(19) United States
(12) Patent Application Publication
(10) Pub. No.: US 2021/0394390 A1
(43) Pub. Date: Dec. 23, 2021

(54) ASYMMETRICAL CORNER JOINT AND TOOLS FOR MAKING SAME

(71) Applicant: David G.P. BEAVEN, Hope (CA)

(72) Inventor: David G.P. BEAVEN, Hope (CA)

(21) Appl. No.: 17/276,239

(22) PCT Filed: Sep. 17, 2019
(86) PCT No.: PCT/CA2019/051316

§ 371 Date: Mar. 15, 2021

Related U.S. Application Data
(60) Provisional application No. 62/732,348, filed on Sep. 17, 2018.

(51) Int. Cl. B27G 5/04; F16B 12/46

(52) U.S. Cl. CPC B27G 5/04; F16B 12/46

(57) ABSTRACT

An asymmetrical corner joint in a material having a planar surface, in which one side of the joint is shaped to be a slanted plane and the other side of the joint is shaped to be a beveled plane and a shoulder plane, such that when the joint is formed the slanted plane and beveled plane abut and the shoulder plane abuts a portion of the planar surface adjacent the slanted plane. A tool set for use with a router for shaping the two sides of the asymmetrical corner joint in one pass, the tool set including a bit with an angle cutting portion and a shoulder cutting portion, and a canting base for use with the router for tilting the angle of rotation of the bit such that the angle cutting portion cuts both sides of the cut and the shoulder cutting portion only cuts one side.

### CROSS REFERENCE TO RELATED APPLICATIONS

This application claims the benefit of U.S. Provisional Patent Application No. 62/732,348, filed 17 Sep. 2018, and titled SELF-ALIGNING CORNER JOINT AND TOOLS FOR MAKING SAME.

### FIELD OF THE INVENTION

The present invention relates to the field of corner joints, and tools for making same.

### BACKGROUND OF THE INVENTION

It is often desirable to make a corner joint when working with a panel material (e.g., plywood, plastic panels, etc).

A miter (or mitre) joint is a corner joint made by beveling each of two parts to be joined such that the line of junction between the parts bisects the angle of the corner joint. For example, to form a 90° mitre joint, each part is bevelled at 45°. A mitre joint is conventionally made by passing a rotating blade set at the desired bevel through the work material (e.g., panel) so as to create two parts, and then rotating one of the parts so as to bring the saw cut faces into face-to-face contact, thus forming the corner angle.

It is also known to cut a symmetrical V-groove on one side of a panel that is shallower than the full thickness of the panel so as to leave some material at the base of the V that is sufficiently thin to bend without breaking when the portions of the panel on either side of the V-groove are folded to form the desired corner. For example, U.S. Pat. No. 4,342,349 discloses a grooving tool having a V-shaped blade having a leading cutting edge and means for causing the cutting edge to cut a straight groove, whereby the board material may be folded to form structures for use as boxes and in furniture applications. It is also known to make such symmetrical V-grooves using a suitably shaped router bit or a specialty V-cut circular saw blade or a stack of specialty circular saw blades configured to collectively make the desired V-groove.

The miter lock joint is a corner joint that does not leave the edge grain exposed and additionally aids in the alignment of the two pieces being joined. To make the miter lock joint, the pieces to be joined must be separately passed against a miter lock shaper cutter, in orientations 90 degrees from each other in order to form the mating miter lock joint between them.

US 2016/0135596, Costello et al, published 19 May 2016, discloses a “Stabilized Miter Edge System and Device” essentially involving a combined miter and butt joint created using two thicknesses of material, a narrower material having a conventional miter cut and a thicker material having a corresponding miter cut section and a butt joint section.

### SUMMARY OF THE INVENTION

In one aspect, the present invention is directed to an asymmetrical corner joint in which both of the joint ends comprising the corner joint may be created with one pass of a cutting/shaping device (router driven) and the joint ends have cooperating self aligning features. The corner joint is asymmetrical in that, unlike a miter joint (conventional or more complex, e.g., a lock miter joint) in the asymmetrical corner joint, the plane defined by the portions of the meeting joint ends that extend to the outside corner of the corner joint, does not bisect the outside corner.

In one aspect, the present invention provides an asymmetrical corner joint between: a first piece of work material and a second piece of work material both having the same material thickness, wherein: the first piece of work material has an outer side, an inner side and a first joint end comprising a slant plane extending between the outer side and the inner side, wherein a band of the inner side adjacent the slant plane is planar; and the second piece of work material has a second joint end comprising a beveled plane and a shoulder plane, wherein, with the first piece and the second piece in position to form the corner joint: the beveled plane is adjacent to, and in parallel alignment with, the slant plane; and the shoulder plane is adjacent to, and in parallel alignment with, the planar band of the inner side.

The self alignment of the joint ends is related to one of the angle between the beveled plane and the shoulder plane, and the angle between slant plane and the band of the inner side, being the reflex angle of the other, such that the mating of these angles aligns the joint ends.

In another aspect the present invention provides a tool set for use with a router having an axis of rotation, for forming with one pass the first joint end and second joint end of the asymmetrical corner joint in a work material having a planar inner side, the tool set including: canting means for releasably setting a tilt, being an angle between the router axis of rotation and a notional line normal to the planar inner side; a bevel/shoulder bit including: a proximal shank for releasably mounting the bevel/shoulder bit to the router for rotation by the router about the router axis of rotation; a distal bevel/slant cutter; and a shoulder cutter between the shank and bevel/slant cutter, and adjacent the bevel/slant cutter, wherein, with the router at the tilt, and the router moved relative to the work material, or the work material moved relative to the router, to make a cut with two sides along the planar inner side: on one side of the cut the bevel/slant cutter engages the work material so as to form the first joint end, and on the other side of the cut the bevel/slant cutter and shoulder cutter engage the work material so as to form the second joint end.

Shaping both joint ends with one pass facilitates use of “good-one-side” material as the user need not turn over the work material to achieve a consistent finish on the inside or outside of a corner joint (of the inside or outside of a box, for example, comprising multiple corner joints). Related to this, shaping both joint ends with one pass enables the user to select a cut depth that is less than the material thickness so as to leave residual material to be folded or bent to form a seamless outside corner of the corner joint.

The work material may have a planar outer side parallel to the inner side and thus a material thickness; the corner joint may have a joint angle, being the inside angle defined by the first piece and second piece in position to form the corner joint; the bevel/shoulder bit may have: a cut depth less than or equal to the material thickness; a profile, wherein: the bevel/slant cutter defines two bevel/slant sides with a bevel/slant side length and a bevel/slant angle where the bevel slant sides meet; the shoulder cutter defines two shoulder sides and an associated shoulder side angle, being the angle on the outside of the profile between: the distal side of a notional plane normal to the router axis of rotation and positioned at the proximal end of the shoulder sides; and one of the shoulder sides, wherein: the bevel/slant angle=180°−the joint angle; the shoulder side angle=the joint angle−tilt; and the bevel/slant side length=the cut depth×secant((½×bevel/slant angle)−tilt).

The joint angle may be about 75° to about 135°. The tilt may be about 5° to about 25°. The tilt may be about 10°.

The canting means may include a canting base releasably affixable to the router.

The tool set may be configured for cooperating with a guiding fence, wherein: the tilt has a tilt direction, being from the notional line normal to the planar inner side toward the router axis of rotation; the canting base includes: a first fence slide for use in sliding the canting base along the guiding fence with the tilt direction toward the guiding fence; a second fence slide for use in sliding the canting base along the guiding fence with the tilt direction away from the guiding fence.

The tool set may be for use with a plurality of cut depths, wherein: the bevel/shoulder bit may be one of a plurality of differently sized bevel/shoulder bits with each such bevel/shoulder bit sized for a respective cut depth; the canting base may include a cant body; the second fence slide may be an adjustable fence slide including an adjustable slide body, wherein the distance between the cant body and the adjustable slide body may be user adjustable. The tool set may include one or more adjustable fence slide spacers for interposing between the cant body and adjustable slide body, each such adjustable fence slide spacer sized for use with a respective one of the plurality of differently sized bevel/shoulder bits.

In another aspect, the present invention provides a bevel/shoulder bit for use for forming with one pass the first joint end and second joint end of the asymmetrical corner joint in a work material having a planar inner side, with a router having an axis of rotation and a tilt, being an angle between the router axis of rotation and a notional line normal to the planar inner side, the bevel/shoulder bit including: a proximal shank for releasably mounting the bevel/shoulder bit to the router for rotation by the router about the router axis of rotation; a distal bevel/slant cutter; and a shoulder cutter between the shank and bevel/slant cutter, and adjacent the bevel/slant cutter, wherein, with the router at the tilt, and the router moved relative to the work material, or the work material moved relative to the router, to make a cut with two sides along the planar inner side: on one side of the cut the bevel/slant cutter engages the work material so as to form the first joint end, and on the other side of the cut the bevel/slant cutter and shoulder cutter engage the work material so as to form the second joint end.

The work material may have a planar outer side parallel to the inner side such that the work material has a material thickness; the corner joint may have a joint angle, being the inside angle defined by the first piece and second piece in position to form the corner joint; the bevel/shoulder bit may have: a cut depth less than or equal to the material thickness; a profile, wherein: the bevel/slant cutter defines two bevel/slant sides with a bevel/slant side length and a bevel/slant angle where the bevel slant sides meet; the shoulder cutter defines two shoulder sides and an associated shoulder side angle, being the angle on the outside of the profile between: the distal side of a notional plane normal to the router axis of rotation and positioned at the proximal end of the shoulder sides; and one of the shoulder sides, wherein: the bevel/slant angle=180°−the joint angle; the shoulder side angle=the joint angle−tilt; and the bevel/slant side length=the cut depth×secant((½×bevel/slant angle)−tilt).

The joint angle may be about 75° to about 135°. The tilt may be about 5° to about 25°. The tilt may be about 10°.

### SUMMARY OF THE DRAWINGS

FIG. 1 is a side elevation view showing a bevel/shoulder forming set embodiment of the present invention installed on a handheld router.

FIG. 2 is an exploded view of the embodiment and handheld router shown in FIG. 1.

FIG. 3 is a schematic side-elevation representation of the profile of a 90° joint angle−10° tilt−bevel/shoulder bit, shown aligned for cutting a panel.

FIG. 4 is a perspective view of a canting base embodiment of the present invention, shown with the adjustable fence slide at the smallest setting.

FIG. 5 is a view of a canting base of FIG. 4 and four adjustable fence slide spacers, shown with the adjustable fence slide displaced to receive an adjustable fence slide spacer.

FIG. 6 is a schematic side-elevation representation of the profile of a 90° joint angle−10° tilt−bevel/shoulder bit, shown aligned for cutting a panel.

FIG. 7 is a schematic side-elevation representation of the two parts of the panel of FIG. 6 after a cutting pass of the 90° joint angle−10° tilt−bevel/shoulder bit.

FIG. 8 is a schematic side-elevation representation of the two parts of the panel of FIG. 7, positioned to form a 90° joint.

FIG. 9 is a schematic side-elevation representation of the profile of a 135° joint angle−10° tilt−bevel/shoulder bit, shown aligned for cutting a panel.

FIG. 10 is a schematic side-elevation representation of the two parts of the panel of FIG. 9 after a cutting pass of the 135° joint angle−10° tilt−bevel/shoulder bit.

FIG. 11 is a schematic side-elevation representation of the two parts of the panel of FIG. 10, after a cutting pass of the 135° joint angle−10° tilt−bevel/shoulder bit, positioned to form a 135° joint.

FIG. 12 is a schematic side-elevation representation of the profile of a 75° joint angle−10° tilt−bevel/shoulder bit, shown aligned for cutting a panel.

FIG. 13 is a schematic side-elevation representation of the two parts of the panel of FIG. 12 after a cutting pass of the 75° joint angle−10° tilt−bevel/shoulder bit.

FIG. 14 is a schematic side-elevation representation of the two parts of the panel of FIG. 13, after a cutting pass of the 75° joint angle−10° tilt−bevel/shoulder bit, positioned to form a 75° joint.

FIG. 15 is a schematic side-elevation representation of the profile of a 90° joint angle−25° tilt−bevel/shoulder bit, shown aligned for cutting a panel.

FIG. 16 is a schematic side-elevation representation of the two parts of the panel of FIG. 15 after a cutting pass of the 90° joint angle−25° tilt−bevel/shoulder bit.

FIG. 17 is a schematic side-elevation representation of the two parts of the panel of FIG. 16, after a cutting pass of the 90° joint angle−25° tilt−bevel/shoulder bit, positioned to form a 90° joint.

FIG. 18 is a schematic side-elevation representation of the profile of a 90° joint angle−5° tilt−bevel/shoulder bit, shown aligned for cutting a panel.

FIG. 19 is a schematic side-elevation representation of the two parts of the panel of FIG. 18 after a cutting pass of the 90° joint angle−5° tilt−bevel/shoulder bit.

FIG. 20 is a schematic side-elevation representation of the two parts of the panel of FIG. 19, after a cutting pass of the 90° joint angle−5° tilt−bevel/shoulder bit, positioned to form a 90° joint.

FIG. 21 is a side elevation view of a bevel/shoulder bit embodiment installed in a router table.

FIG. 22 is a schematic side-elevation representation of the profile of a 90° joint angle−10° tilt−shoulder/bevel/shank bit, shown aligned for cutting a panel.

### DETAILED DESCRIPTION WITH REFERENCE TO THE DRAWINGS

Embodiments of the present invention include an asymmetrical corner joint forming set 100 for use with a handheld router 102 for, with one pass, e.g., across a panel 104, creating the mating ends for an asymmetrical corner joint 106, being the slant end 108 and the bevel/shoulder end 110, the latter comprising the bevel face 112 and the shoulder face 114.

In this specification and in the claims, corner joints are in part described in terms of the joint angle 116, being the inside angle defined by the two components that meet to form the corner joint. For example, a right-angle corner is referred to as having a 90° joint angle 116.

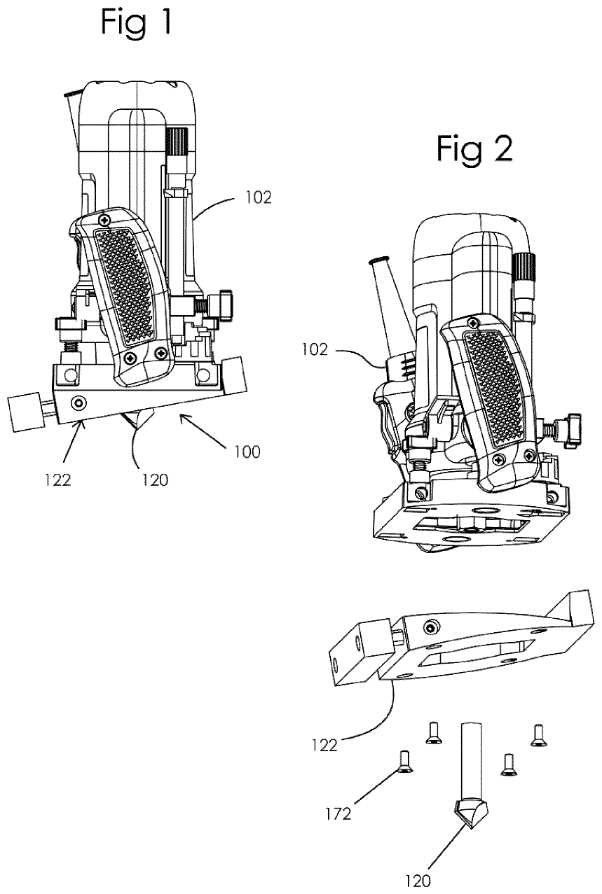

As indicated in FIGS. 1 and 2, the asymmetrical corner joint forming set 100 includes a bevel/shoulder bit 120 and a canting base 122.

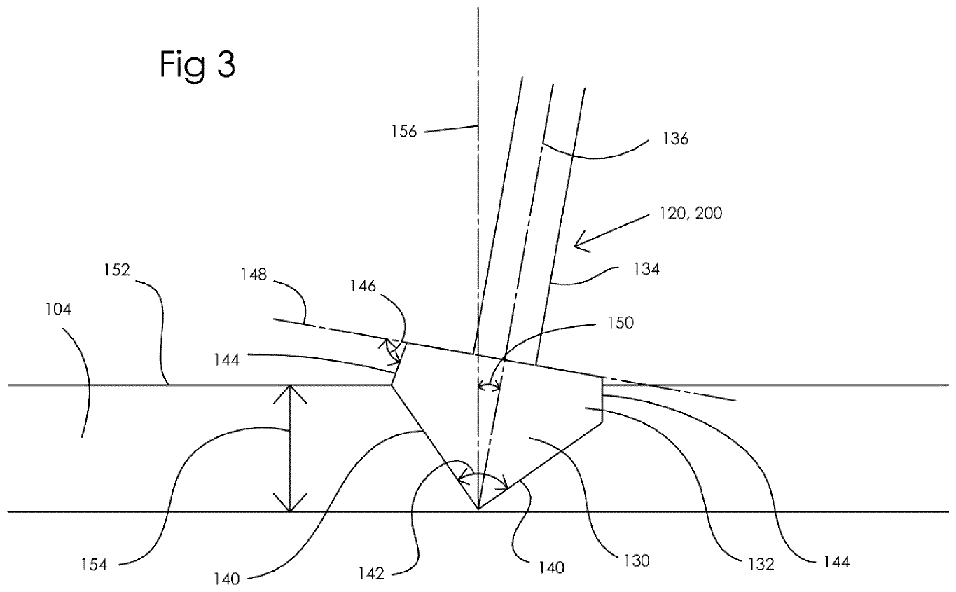

As illustrated in FIG. 3, using the profile of a 90° joint angle−10° tilt−bevel/shoulder bit 200 at a tilt of 10° as an example, each bevel/shoulder bit 120 has a bevel/slant cutter 130, a shoulder cutter 132 and a proximal shank 134. The shank 134 is used to releasably mount the bevel/shoulder cutter 120 to a suitable rotational driver (e.g., a handheld router 102), and thus defines the bevel/shoulder cutter axis of rotation 136. Each of the bevel/slant cutter 130 and shoulder cutter 132, has one or more cutting edges, which along with the bevel/shoulder cutter axis of rotation 136, defines the profile of the bevel/shoulder bit 120.

Each bevel/shoulder bit profile includes two equal-length bevel/slant sides 140 meeting in a point defining the bevel/slant angle 142, which is bisected by the bevel/shoulder cutter axis of rotation 136. Each bevel/slant side 140 meets a respective shoulder side 144. The shoulder sides 144 are equal in length one to the other. The shoulder sides 144 define a shoulder side angle 146 (relative to the axis of rotation), which herein is defined in terms of a notional plane 148 normal to the bevel/shoulder cutter axis of rotation 136 and positioned at the proximal end of the shoulder sides 144, wherein the shoulder side angle 146 is measured on the outside of the bevel/shoulder bit profile between the distal side of the notional plane normal to the shank 148 and a one of the shoulder sides 144.

A router 102 is conventionally configured to have a router axis of rotation that is normal to the surface of the work material. In use, the canting base 122 cants the bevel/shoulder cutter axis of rotation 136 to a tilt 150, being the angle between the bevel/shoulder cutter axis of rotation 136 and a notional line 156 normal from the surface of the work material (e.g., the panel surface 152).

The profile and size of a bevel/shoulder bit 120 suitable for a particular application may be determined from: the cut depth 154 (which may be the full thickness of the work material or may be a lesser depth so as to leave residual material to create a seamless bend on the outside corner of the relevant joint); the desired joint angle 116; and the tilt 150. The bevel/slant angle 142=180°−joint angle 116. The length of the bevel/slant side 140=cut depth 154×secant((½×bevel/slant angle 142)−tilt 150). The shoulder side angle 146=joint angle 116−tilt 150.

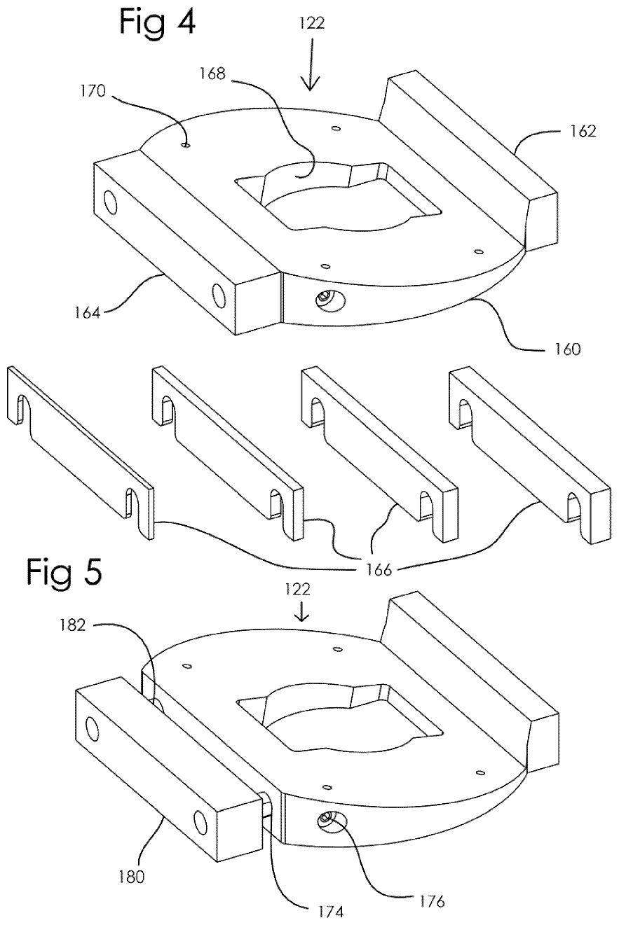

As indicated in FIGS. 4 and 5, the canting base 122 includes a cant body 160, a fixed fence slide 162, an adjustable fence slide 164 and adjustable fence slide spacers 166. The cant body 160 includes: a bit port 168, fastener holes 170 (for receiving machine screws 172 for attaching the canting base 122 to a router 102), shaft receiving bores 174 and set-screws 176. In the embodiment shown in the drawings, the cant body 160 and fixed fence slide 162 are integral one to the other.

The adjustable fence slide 164 includes an adjustable slide body 180 and two projecting shafts 182. In use, the projecting shafts 182 are inserted into the shaft receiving bores 174 and the set screws are used to secure the projecting shafts 182 in the shaft receiving bores 174 in a selected desired position, being: with the adjustable slide body 180 abutting the cant body 160; with a user selected space between the adjustable slide body 180 and the cant body 160; or with one or more adjustable fence slide spacers 166 interposed between the adjustable slide body 180 and the cant body 160.

The fixed fence slide 162 and adjustable fence slide 164 are intended to slide along a fence (not shown) positioned and secured by the user, to guide the router 102 (with installed asymmetrical corner joint forming set 100) for a cut. The cut will in most instances be straight (i.e., linear) but it is understood that a curved cut would work (e.g., with kerf cutting to permit the material on one side of the joint to bend to conform to the curve).

In some instances, e.g., when making multiple joints from a single panel (e.g., when making a box or drawer from one piece of plywood), to ensure that the appropriate ends meet to form a joint (i.e., slant end 108 to bevel/shoulder end 110), it may be desirable or necessary to turn the router 102 (with installed asymmetrical corner joint forming set 100) 180° at a location along the length of a cut, so as to switch from sliding the fixed fence slide 162 along the fence to sliding the adjustable fence slide 164 along the fence. The size of the bevel/shoulder bit 120 is different for different cut depths 154. Due to the tilt 150, the lateral displacement of the tip of the bevel/shoulder bit 120 from the portion of the fixed fence slide 162 that slides along the fence, is different for bevel/shoulder bits 120 of different sizes. That is, the lateral displacement of the tip of the bevel/shoulder bit 120 from the portion of the fixed fence slide 162 that slides along the fence, is less for a smaller bevel/shoulder bit 120 than it is for a larger bevel/shoulder bits 120.

The adjustable fence slide 164 is used to adjust for the difference in lateral displacement of different sizes of bevel/shoulder bits 120. The adjustable fence slide 164 is configured such that with a bevel/shoulder bit 120 of the smallest usable size (i.e., sized for a minimum usable cut depth 154/material thickness) the adjustable slide body 180 is brought into abutment with the cant body 160 and held thus by securing the set-screws 176 against the projecting shafts 182 (within the shaft receiving bores 174). With the adjustable fence slide 164 so set, for the relevant size of bevel/shoulder bit 120, the lateral displacement of the tip of the bevel/shoulder bit 120 (and thus the line defining the outside corner of the relevant joint), will be equidistant from the fence, whether the fixed fence slide 162 or the adjustable fence slide 164 is slid along the fence during cutting.

Similarly, the adjustable fence slide spacers 166 are sized to accommodate the additional lateral displacement of the tip of the bevel/shoulder bit 120 in increments suitable for a selection of useful sizes of bevel/shoulder bits 120 (i.e., common material thicknesses/cut depths 154), such that with a suitable adjustable fence slide spacer 166 interposed between the adjustable slide body 180 and the cant body 160, (with the adjustable slide body 180 and the cant body 160 secured relative to each other with the set-screws 176), the lateral displacement of the tip of the bevel/shoulder bit 120 (and thus the line defining the outside corner of the relevant joint), will be equidistant from the fence, whether the fixed fence slide 162 or the adjustable fence slide 164 is slid along the fence during cutting.

Alternatively, the user may determine a desirable distance between the adjustable slide body 180 and the cant body 160, and secure the adjustable slide body 180 and the cant body 160 in the desired spaced-apart relationship with the set-screws, without use of the adjustable fence slide spacers 166.

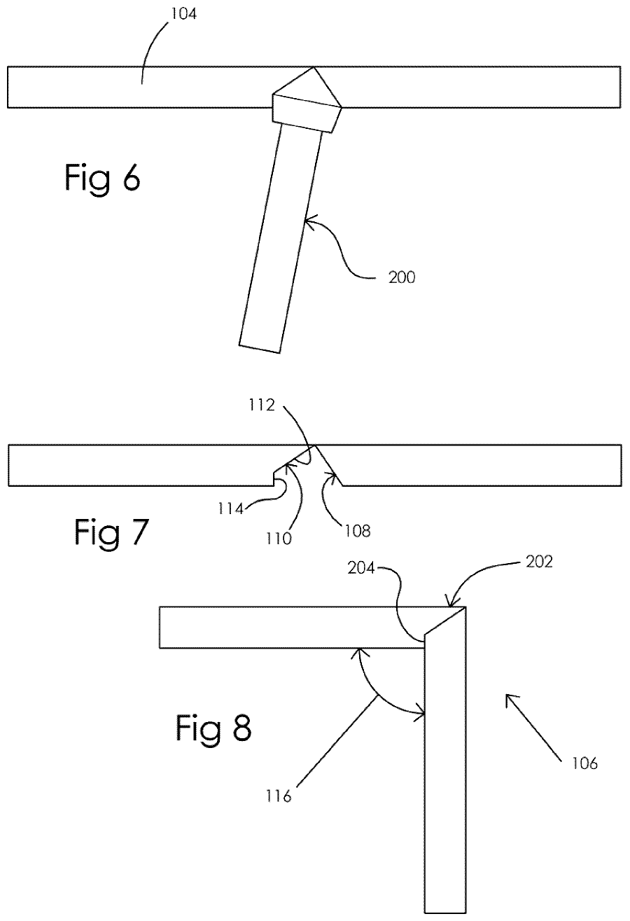

FIG. 6 shows the profile of a 90° joint angle−10° tilt−bevel/shoulder bit 200, for use with a canting base 122 providing a tilt of 10°, for use in creating, from a panel 104 with one pass, the slant end 108 and bevel/shoulder end 110 for a 90° asymmetrical corner joint 202. FIG. 7 shows the slant end 108 and bevel/shoulder end 110 created in a panel 104 by a pass of the 90° joint angle−10° tilt−bevel/shoulder bit 200 at a tilt of 10°. FIG. 8 shows the slant end 108 and bevel/shoulder end 110 created in a panel 104 by a pass of the 90° joint angle−10° tilt−bevel/shoulder bit 200 at a tilt of 10°, positioned to form a 90° asymmetrical corner joint 202.

As indicated in FIG. 8, the slant end 108 and bevel face 112 abut one another and the plane defined by the abutment of the slant end 108 and bevel face 112, is biased, in that the plane does not bisect the joint angle. The shoulder face 114 abuts the surface bonding strip 204, being a portion of the panel surface 152 immediately adjacent the slant end 108.

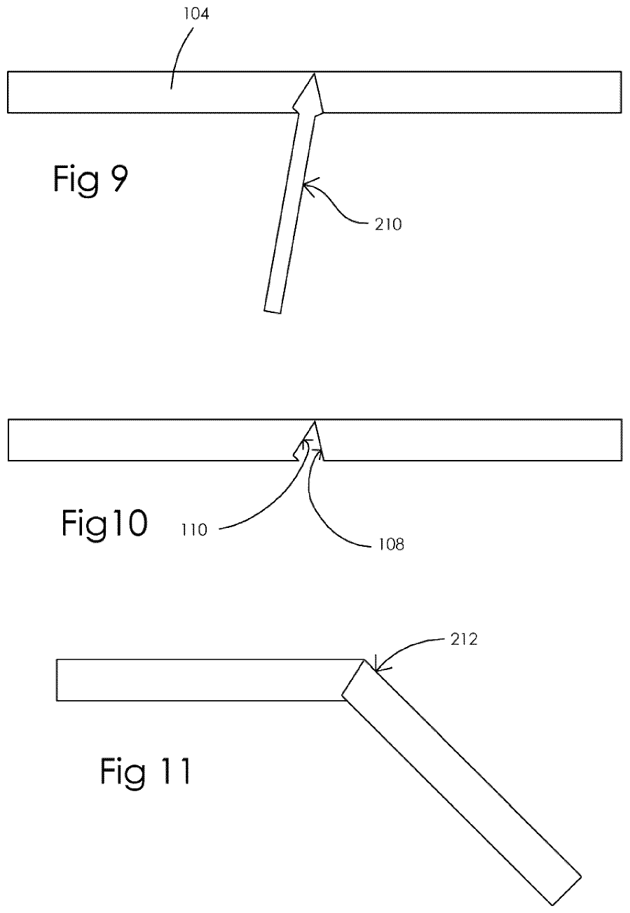

FIG. 9 shows the profile of a 135° joint angle−10° tilt−bevel/shoulder bit 210, for use with a canting base 122 providing a tilt of 10°, for use in creating, from a panel 104 with one pass, the slant end 108 and bevel/shoulder end 110 for a 135° asymmetrical corner joint 212. FIG. shows the slant end 108 and bevel/shoulder end 110 created in a panel 104 by a pass of the 135° joint angle−10° tilt−bevel/shoulder bit 210 at a tilt of 10°. FIG. 11 shows the slant end 108 and bevel/shoulder end 110 created in a panel 104 by a pass of the 135° joint angle−10° tilt−bevel/shoulder bit 210 at a tilt of 10°, positioned to form a 135° asymmetrical corner joint 212.

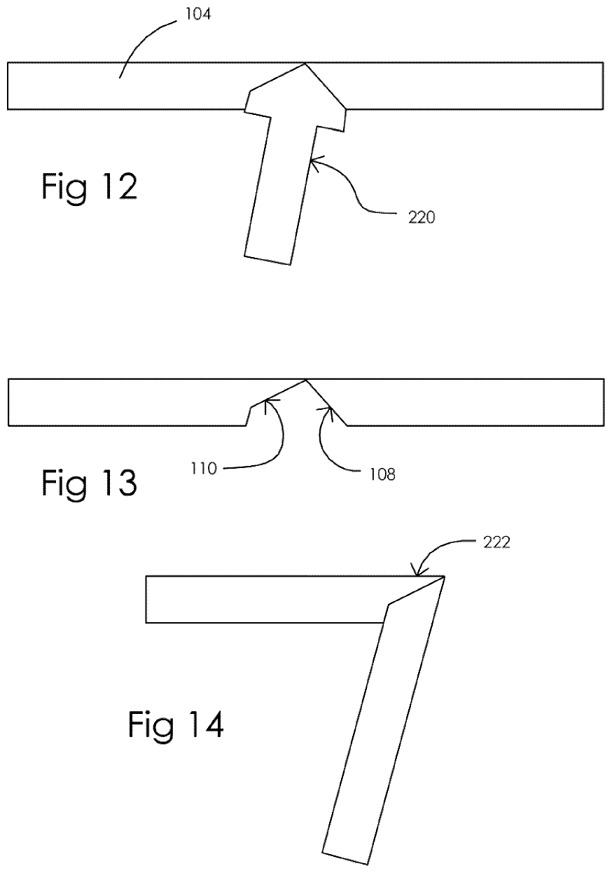

FIG. 12 shows the profile of a 75° joint angle−10° tilt−bevel/shoulder bit 220, for use with a canting base 122 providing a tilt of 10°, for use in creating, from a panel 104 with one pass, the slant end 108 and bevel/shoulder end 110 for a 75° asymmetrical corner joint 222. FIG. 13 shows the slant end 108 and bevel/shoulder end 110 created in a panel 104 by a pass of the 75° joint angle−10° tilt−bevel/shoulder bit 220 at a tilt of 10°. FIG. 14 shows the slant end 108 and bevel/shoulder end 110 created in a panel 104 by a pass of the 75° joint angle−10° tilt−bevel/shoulder bit 220 at a tilt of 10°, positioned to form a 75° asymmetrical corner joint 222.

The shoulder face depth, being the distance measured perpendicular from a plane defined by the panel surface 152 adjacent the shoulder face 114, to the inner extent of the shoulder face 114 (i.e., where the shoulder face 114 meets the bevel face 112), may be varied by altering the tilt 150 and the profile.

In abstract theoretical terms, the tilt could range from >0° to <90°. However, there are practical limits to the range of usable tilts. A tilt approaching 0° would produce a minimal shoulder face 114, thus reducing the self-aligning efficacy of the joint. An extreme tilt (e.g., say exceeding 45°) would involve the conflicting demands of: a reduction in the shank diameter (at least in the vicinity of the shoulder cutter) to enable the shank to clear the panel during cutting; and lengthening of the shank to accommodate the displacement of the router away from the panel surface associated with such a tilt.

For a 90° joint, a usable tilt range is understood to be from about 5° to about 25°. For most applications, it is understood that a tilt of about 10° provides acceptable utility. However, in applications involving uneven forces as between the panel on each side of the joint, for example in a stair where one side of the joint is a tread and the other side of joint is a riser supporting the tread, it would be prudent to have the bevel/shoulder end 110 on the riser (so as to provide a horizontal shoulder face 114 to support the tread) and it may be desirable to enlarge/deepen the shoulder face 114.

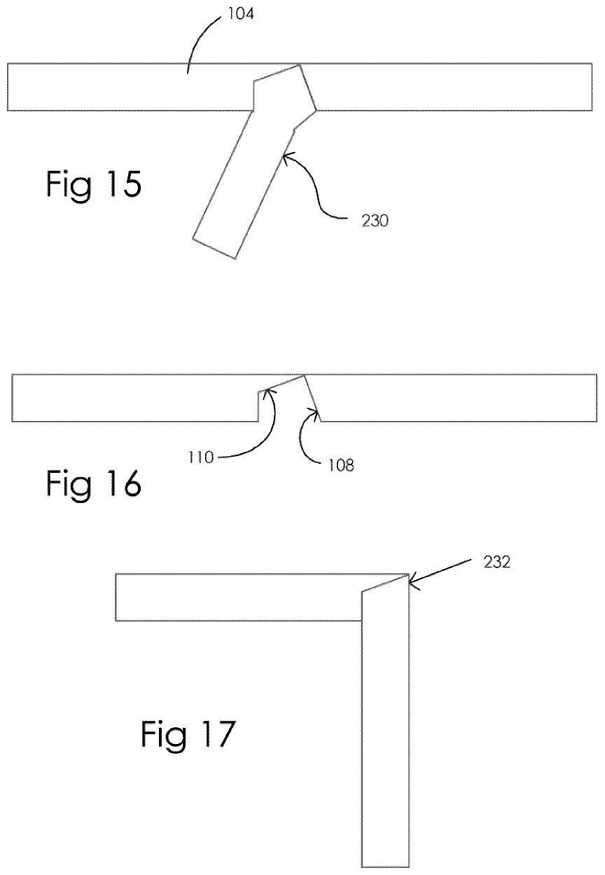

FIG. 15 shows the profile of a 90° joint angle−25° tilt−bevel/shoulder bit 230, for use in creating, from a panel 104 with one pass, the slant end 108 and bevel/shoulder end 110 for a 90° deep-shoulder asymmetrical corner joint 232. FIG. 16 shows the slant end 108 and bevel/shoulder end 110 created in a panel 104 by a pass of the 90° joint angle−25° tilt−bevel/shoulder bit 232 at a tilt of 25°. FIG. 17 shows the slant end 108 and bevel/shoulder end 110 created in a panel 104 by a pass of the 90° joint angle−25° tilt−bevel/shoulder bit 230 at a tilt of 25°, positioned to form a 90° deep-shoulder asymmetrical corner joint 232.

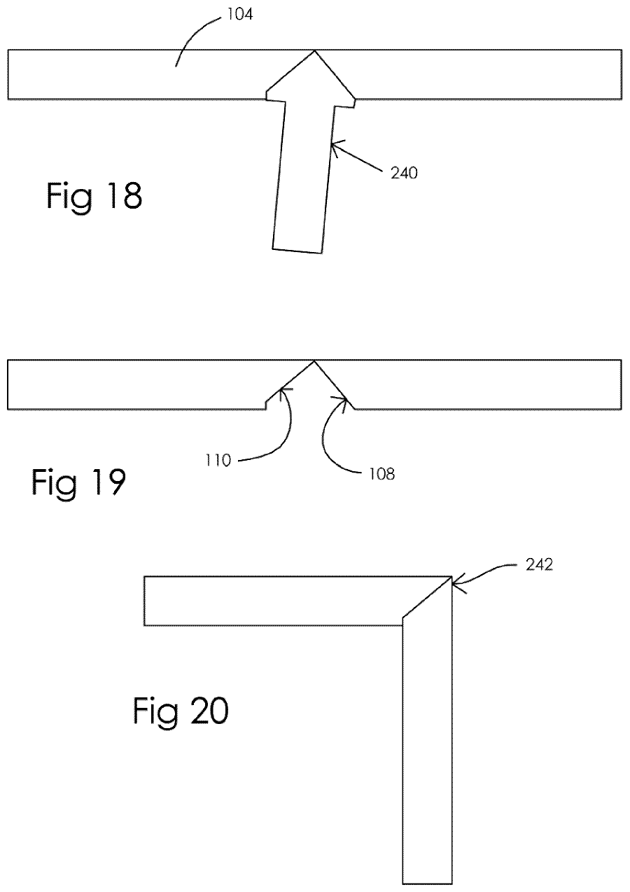

FIG. 18 shows the profile of a 90° joint angle−5° tilt−bevel/shoulder bit 240, for use in creating, from a panel 104 with one pass, the slant end 108 and bevel/shoulder end 110 for a 90° shallow-shoulder asymmetrical corner joint 242. FIG. 19 shows the slant end 108 and bevel/shoulder end 110 created in a panel 104 by a pass of the 90° joint angle−5° tilt−bevel/shoulder bit 242 at a tilt of 5°. FIG. 20 shows the slant end 108 and bevel/shoulder end 110 created in a panel 104 by a pass of the 90° joint angle−5° tilt−bevel/shoulder bit 240 at a tilt of 5°, positioned to form a 90° shallow-shoulder asymmetrical corner joint 242.

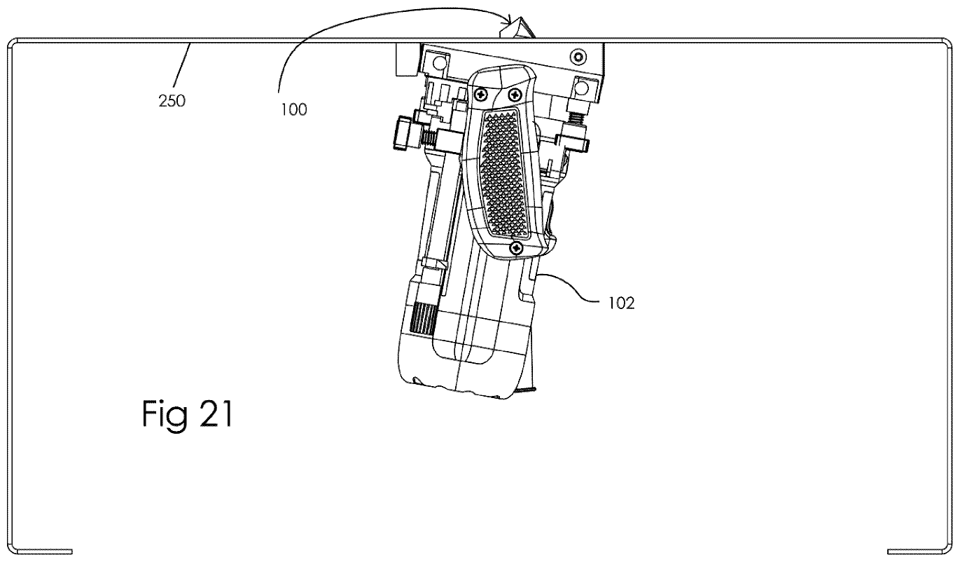

As shown in FIG. 21, the asymmetrical corner joint forming set 100 may be used with a router 102 installed in a router table 250.

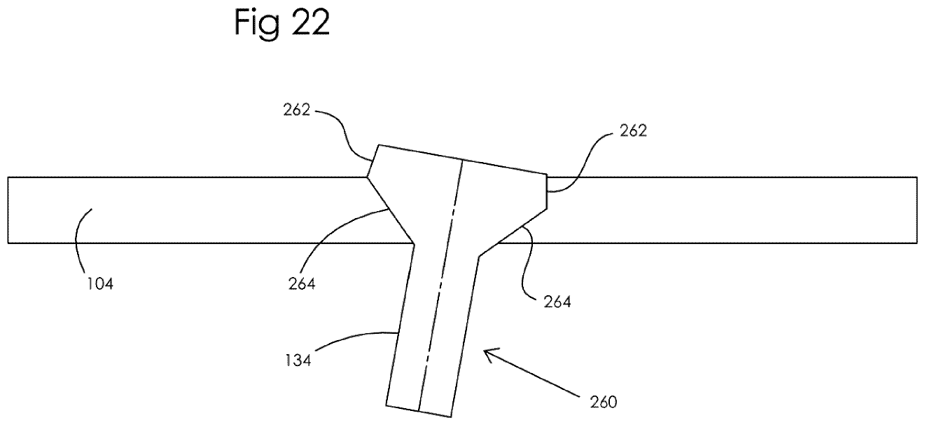

An alternative embodiment providing some of the benefits of the embodiments described above is illustrated in FIG. 22 with the exemplary profile of a 90° joint angle−10° tilt−shoulder/bevel/shank bit 260, shown aligned for cutting a panel 104. As illustrated in FIG. 22, the 90° joint angle−10° tilt−shoulder/bevel/shank bit 260 has a proximal shank 134, a distal shoulder cutter 262 and, located between the proximal shank 134 and the distal shoulder cutter 262, a tipless bevel/slant cutter 264. As is apparent from FIG. 22, with a corner joint created using the 90° joint angle−10° tilt−shoulder/bevel/shank bit 260, the joint seam will not align with the outside corner, which may be a desirable feature (for instance if the work material is rough or uneven, or if it is desirable to round (i.e., “bullnose”) the outside corner.

In this specification and in the claims, the term “about” means plus or minus 20% of the number to which the instance of “about” refers.

The scope of the claims should not be limited by the preferred embodiments set forth in the examples, but should be given the broadest interpretation consistent with the description as a whole.

What is claimed is:

1. An asymmetrical corner joint between:
a first piece of work material and a second piece of work material both having the same material thickness, wherein:
the first piece of work material has an outer side, an inner side and a first joint end comprising a slant plane extending between the outer side and the inner side, wherein a band of the inner side adjacent the slant plane is planar; and
the second piece of work material has a second joint end comprising a beveled plane and a shoulder plane,
wherein, with the first piece and second piece in position to form the corner joint:
the beveled plane is adjacent to, and in parallel alignment with, the slant plane; and
the shoulder plane is adjacent to, and in parallel alignment with, the planar band of the inner side.

2. A tool set for use with a router having an axis of rotation, for forming with one pass the first joint end and second joint end of claim 1 in a work material having a planar inner side, the tool set comprising:
canting means for releasably setting a tilt, being an angle between the router axis of rotation and a notional line normal to the planar inner side;
a bevel/shoulder bit comprising:
a proximal shank for releasably mounting the bevel/shoulder bit to the router for rotation by the router about the router axis of rotation;
a distal bevel/slant cutter; and
a shoulder cutter between the shank and bevel/slant cutter, and adjacent the bevel/slant cutter,
wherein, with the router at the tilt, and the router moved relative to the work material, or the work material moved relative to the router, to make a cut with two sides along the planar inner side:
on one side of the cut the bevel/slant cutter engages the work material so as to form the first joint end, and
on the other side of the cut the bevel/slant cutter and shoulder cutter engage the work material so as to form the second joint end.

3. The tool set of claim 2, wherein:
the corner joint has a joint angle, being the inside angle defined by the first piece and second piece in position to form the corner joint;
the bevel/shoulder bit has:
a cut depth less than or equal to the material thickness;
a profile, wherein:
the bevel/slant cutter defines two bevel/slant sides with a bevel/slant side length and a bevel/slant angle where the bevel slant sides meet;
the shoulder cutter defines two shoulder sides and an associated shoulder side angle, being the angle on the outside of the profile between:
the distal side of a notional plane normal to the router axis of rotation and positioned at the proximal end of the shoulder sides; and
one of the shoulder sides,
wherein:
the bevel/slant angle=180°−the joint angle;
the shoulder side angle=the joint angle−tilt; and
the bevel/slant side length=the cut depth×secant((½×bevel/slant angle)−tilt).

4. The tool set of claim 3, wherein the joint angle is about 75° to about 135°.

5. The tool set of claim 2, wherein the tilt is about 5° to about 25°.

6. The tool set of claim 4, wherein the tilt is about 10°.

7. The tool set of claim 2, wherein the canting means comprises a canting base releasably affixable to the router.

8. The tool set of claim 7, configured for cooperating with a guiding fence, wherein:
the tilt has a tilt direction, being from the notional line normal to the planar inner side toward the router axis of rotation;
the canting base comprises:
a first fence slide for use in sliding the canting base along the guiding fence with the tilt direction toward the guiding fence;
a second fence slide for use in sliding the canting base along the guiding fence with the tilt direction away from the guiding fence.

9. The tool set of claim 8, for use with a plurality of cut depths, wherein:
the bevel/shoulder bit is one of a plurality of differently sized bevel/shoulder bits with each such bevel/shoulder bit sized for a respective cut depth;
the canting base comprises a cant body;
the second fence slide is an adjustable fence slide comprising an adjustable slide body, wherein the distance between the cant body and the adjustable slide body is user adjustable.

10. The tool set of claim 9, further comprising one or more adjustable fence slide spacers for interposing between the cant body and adjustable slide body, each such adjustable fence slide spacer sized for use with a respective one of the plurality of differently sized bevel/shoulder bits.

11. A bevel/shoulder bit for use for forming with one pass the first joint end and second joint end of claim 1 in a work material having a planar inner side, with a router having an axis of rotation and a tilt, being an angle between the router axis of rotation and a notional line normal to the planar inner side, the bevel/shoulder bit comprising:
a proximal shank for releasably mounting the bevel/shoulder bit to the router for rotation by the router about the router axis of rotation;
a distal bevel/slant cutter; and
a shoulder cutter between the shank and bevel/slant cutter, and adjacent the bevel/slant cutter,
wherein, with the router at the tilt, and the router moved relative to the work material, or the work material moved relative to the router, to make a cut with two sides along the planar inner side:
on one side of the cut the bevel/slant cutter engages the work material so as to form the first joint end, and
on the other side of the cut the bevel/slant cutter and shoulder cutter engage the work material so as to form the second joint end.

12. The bevel/shoulder bit of claim 11, wherein:
the work material has a planar outer side parallel to the inner side, wherein the work material has a material thickness;
the corner joint has a joint angle, being the inside angle defined by the first piece and second piece in position to form the corner joint;
the bevel/shoulder bit has:
a cut depth less than or equal to the material thickness;
a profile, wherein:
the bevel/slant cutter defines two bevel/slant sides with a bevel/slant side length and a bevel/slant angle where the bevel slant sides meet;
the shoulder cutter defines two shoulder sides and an associated shoulder side angle, being the angle on the outside of the profile between:
the distal side of a notional plane normal to the router axis of rotation and positioned at the proximal end of the shoulder sides; and
one of the shoulder sides,
wherein:
the bevel/slant angle=180°−the joint angle;
the shoulder side angle=the joint angle−tilt; and
the bevel/slant side length=the cut depth×secant((½×bevel/slant angle)−tilt).

13. The bevel/shoulder bit of claim 12, wherein the joint angle is about 75° to about 135°.

14. The bevel/shoulder bit of claim 12, wherein the tilt is about 5° to about 25°.

15. The bevel/shoulder bit of claim 14, wherein the tilt is about 10°.
